(19) United States
(12) Patent Application Publication
(10) Pub. No.: US 2025/0383699 A1
(43) Pub. Date: Dec. 18, 2025

(54) MANAGING POWER DELIVERY TO COMPONENTS OF A MEMORY SUB-SYSTEM USING MACHINE LEARNING MODELS

(71) Applicant: Micron Technology, Inc., Boise, ID (US)

(72) Inventors: Joseph Louis Turmes, Nampa, ID (US); David A. Holmstrom, Morgan Hill, CA (US)

(21) Appl. No.: 19/229,277

(22) Filed: Jun. 5, 2025

Related U.S. Application Data
(60) Provisional application No. 63/659,156, filed on Jun. 12, 2024.

(51) Int. Cl. G06F 1/3228; G06N 20/00

(52) U.S. Cl. CPC G06F 1/3228; G06N 20/00

(57) ABSTRACT

A current workload is received from a host system. One or more characteristics of the current workload and one or more operational characteristics of a memory sub-system is provided as input to a machine learning model. The machine learning model is trained to identify one or more parameters and corresponding predicted parameter values of a power management integrated circuit (PMIC) of the memory sub-system. The one or more parameters and corresponding predicted parameter values are used to distribute power one or more components of the memory sub-system. An output of the machine learning model is obtained. The output includes the one or more parameters and corresponding predicted parameter values. The one or more parameters of the PMIC is adjusted based on the one or more parameters and corresponding predicted parameter values.

### RELATED APPLICATIONS

This application claims the benefit of U.S. Provisional Patent Application No. 63/659,156 filed June 12, 2024, the contents of which is incorporated by reference in its entirety herein.

### TECHNICAL FIELD

Embodiments of the disclosure relate generally to memory sub-systems, and more specifically, relate to managing power delivery to components of a memory sub-system using machine learning models.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2 illustrates an example memory sub-system, in accordance with some embodiments of the present disclosure.

FIG. 3 illustrates an example data structure storing a set of parameters and parameter values, in accordance with some embodiments of the present disclosure.

FIG. 4 is a flow diagram of an example method for managing power delivery to components of a memory sub-system in accordance with some embodiments of the present disclosure.

FIG. 5 is a block diagram of an example computer system in which embodiments of the present disclosure may operate.

### DETAILED DESCRIPTION

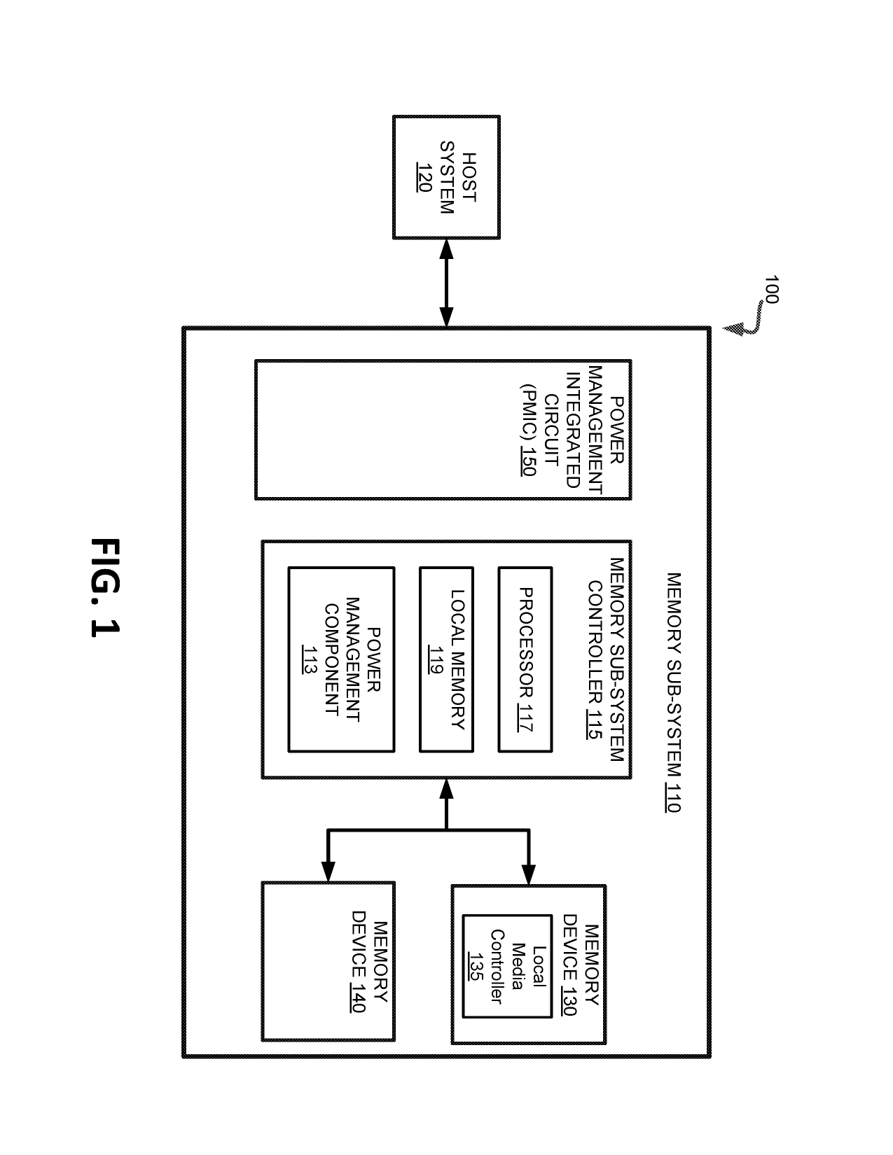

Aspects of the present disclosure are directed to managing power delivery to components of a memory sub-system using machine learning models. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

The host system, via a power supply unit, can distribute the power to the memory sub-system and other attached devices. The host system manages the distribution of power to the memory sub-system and other attached devices by providing power limits to the memory sub-system and other attached devices. The power limit sets a maximum threshold for an amount of power that the memory sub-system and other attached devices can consume or draw from the host system.

As memory subsystems are continuously enhanced with higher data transfer rates, increased storage densities, and advanced controller functionalities, the demand for increased power often arises. These enhancements drive the memory subsystem and its components to consume more power to sustain their improved performance and capabilities. However, due to power limits imposed by the host system, the memory subsystem and its components are restricted in their ability to further improve performance based on these features. Consequently, enhancing power efficiency will be essential to continue advancing performance within the memory subsystem and its components.

In some memory subsystems, components such as memory devices and memory subsystem controllers tend to consume more power than others. Therefore, efforts to enhance power efficiency in the memory subsystem often target improvements in these components, focusing on reducing power consumption while maintaining or even enhancing performance. This involves implementing various techniques such as power management, error correction, and memory management operations within the memory subsystem controller or memory devices. However, despite ongoing advancements in power efficiency, there are inherent technological limits that define the extent to which power consumption can be reduced without compromising the performance or functionality of the components and the memory subsystem as a whole. Therefore, as memory sub-systems approach their imposed power limits and the power efficiency of the most power consuming components are improved to their technological limits there is a need to seek further enhancement and power savings elsewhere.

Aspects of the present disclosure address the above and other deficiencies by dynamically adjusting a distribution of power within the memory sub-system (e.g., to various components of the memory sub-system) using a machine learning model. A machine learning model can implement one or more levels of linear and/or non-linear operations (e.g., a support vector machine [SVM]or a neural network. As an example, a neural network model can have one or more hidden layers and can be trained by adjusting weights of a neural network in accordance with a backpropagation learning algorithm or the like. In some implementations, the various components of the memory sub-system can include, for example, one or more memory devices, a memory sub-system controller, a back-up capacitor, and a power management integrated circuit (PMIC).

The memory sub-system controller can monitor the operational characteristics of the memory sub-system. For example, the operational characteristics may include power consumption, power state, performance (e.g., input/output operations per second (IOPS) or megabytes per second (MB/s)), charge level, temperature, data state metric (e.g., raw bit error rate (RBER)), workload characteristics, historical workloads, and any other suitable operational characteristic of the various components of the memory sub-system.

“Workload” refers to a sequence of one or more memory access operations, such as read operations, write operations, and/or erase operations which are generated by host applications to be processed by the memory sub-system. Workloads characteristics can indicate whether the host or the memory sub-system generated the workload, whether the workload includes reads or writes, whether the workload is sequential or random, whether the workload is aligned or unaligned, or a block size of the workload. Historical workload refers to any workload that were executed by the memory sub-system after training of the machine learning model.

Responsive to receiving a current workload by the memory sub-system, the memory sub-system provides characteristics of the current workload (e.g., number of bytes to write to a specified plane) and the operational characteristics of the various components as input to a machine learning model, which has been trained using a plurality of sample workloads to output a set of parameters and their corresponding predicted parameter values. The set of parameters and their corresponding predicted parameter values corresponds to parameters of the PMIC which specify a predicted power to be distributed to the various components of the memory sub-system, by the PMIC, to efficiently execute the workload, maximize performance, and reduce ambient temperature of the memory sub-system. The set of parameters includes, for example, memory sub-system controller voltage, programming voltage of the memory device(s), backup capacitor trigger, power credit, channel traffic prioritization, etc. Backup capacitor trigger indicates to a PMIC that power should be pulled from the backup capacitor to service operations of the memory sub-system. Voltage to program wordlines (e.g., programming voltage) are generated by charge pumps which are supplied by via power lines. Accordingly, programming voltage can be adjusted, by adjusting power lines supplying power to the charge pumps, to speed up programming times and improve efficiency.

In some embodiments, the set of parameters may further include clock speed of the memory sub-system controller, operations of sub-functions of the memory sub-system controller, and prioritization of traffic flow. For example, based on the set of parameters associated with the clock speed of the memory sub-system controller, the PMIC communicates to the memory sub-system controller to increase or decrease the clock speed of the memory sub-system controller.

The memory sub-system controller receives, from the machine learning model, the set of parameters and their corresponding predicted parameter values. The memory sub-system controller determines whether to update, based on the set of parameters and their corresponding predicted parameter values, a power management table. Each entry of the power management table is identified by a parameter of the set of parameters and includes a current parameter value. Accordingly, the memory sub-system controller compares, for each parameter of the set of parameters, a corresponding predicted parameter value with a current parameter value in a corresponding entry of the power management table. If any predicted parameter value differs from a current parameter value in a corresponding entry of the power management table, the memory sub-system updates the corresponding entry of the power management table with the predicted parameter value. The power management table may be stored in the memory device of the memory sub-system.

Based on an update to the power management table, the PMIC may adjust power distribution to one or more components, via respective power lines. For example, the operational characteristics may indicate a high ambient temperature, thus the machine learning model may output a set of parameters and their corresponding predicted parameter values that results in a reduction in the voltage delivered to the memory sub-system controller and memory device (e.g., the memory sub-system controller voltage and the programming voltage of the memory device(s)).

In another example, the operational characteristics may indicate high ambient temperature, thus the machine learning model may output a set of parameters and their corresponding predicted parameter values that results in a reduction the power credit which reduces the throughput of the memory sub-system (e.g., a speed of sequential reads, sequential writes, random reads, and random writes) without adjusting the voltage which may increase error rates. In particular, decreasing volage too much can cause error rates to increase, and increase voltage too much can impact performance. Accordingly, error rates are monitored to ensure that voltages decrease or increase too much using a threshold which indicates whether the voltage can be decrease or increased further.

In yet another example, the operational characteristics may predict a certain level of impact on power consumption by the current workload (e.g., low impact), thus the machine learning model may output a set of parameters and their corresponding predicted parameter values that results in a reduction in the voltage delivered to the memory sub-system controller and memory device.

In yet another example, the operational characteristics may indicate increased power usage during a specific type of occurrence (e.g., burst of writes), thus the machine learning model may output a set of parameters and their corresponding predicted parameter values that results in a reduction in the backup capacitor trigger thereby redirecting power from the backup capacitor to other components of the memory sub-system (e.g., the memory device(s)) in anticipation of the specific type of occurrence. In yet another example, the operational characteristics may indicate that one or more components have a temperature that exceed a predetermined threshold indicating that the components are running hot (e.g., hot components), thus the machine learning model may output a set of parameters and their corresponding predicted parameter values that results in a reduction in the voltage delivered to the hot components.

In some embodiments, the machine learning model may maintain knowledge of inputs (e.g., the operational characteristics) and resulting outputs (e.g., the set of parameters and their corresponding predicted parameter values) to dynamically learn from the interdependence between the inputs and resulting outputs. Additionally, the machine learning model may be periodically (e.g., every predetermined period of time) retrained based on the historical workload.

Advantages of the present disclosure include, but are not limited to, dynamically adjusting the distribution of power to the various components of the memory sub-system, thereby improving power, efficiency, and performance of the memory sub-system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 can include a power management integrated circuit (PMIC) 150 which is responsible for regulating, distributing, and managing power received from a power source (e.g., power from host system 120) to ensure that various components within the memory sub-system 110 (e.g., memory device 130 and/or 140, memory sub-system controller 115) receive stable and appropriate voltage levels for proper operations. In some embodiments, the appropriate voltage levels may be dictated by a table of preset values or configurations which provides the required voltage and power levels for each of the various components within the memory sub-system 110. The PMIC 150 supplies, using multiple voltage line, power to the various components within the memory sub-system 110. Each component of the various components is connected to the PMIC 150 using one or more voltage rails. Backup capacitor, or simply capacitor, provides temporary power supply to the memory sub-system experiencing loss of power, also referred to herein as asynchronous power loss (APL) or an APL event, to prevent data loss or other adverse effects.

The memory sub-system 110 includes a power management component 113 that can monitor the various components of the memory sub-system 110 for a plurality of operational characteristics used by a machine learning (ML) model to obtain a set of parameters and their corresponding predicted parameter values to dynamically adjust power delivered to the various components. In some embodiments, the power management component 113 is part of the host system 120, a server, an application, or an operating system. In other embodiments, the memory sub-system controller 115, the local media controller 135, and/or any other component of the memory sub-system 110 includes at least a portion of power management component 113 and is configured to perform the functionality described herein.

The power management component 113 can monitors a plurality of operational characteristics of the memory sub-system 110. Each component of the memory sub-system 110 may provide one or more operational characteristics to the power management component 113. In some embodiments, the memory sub-system controller 115 may provide, to the power management component 113, power consumption, temperature, power state, or any other suitable operational characteristics of the memory sub-system controller 115. Power consumption refers to the amount of electrical power consumed over a specific period of time. Power state refers to whether the component (e.g., the memory sub-system controller 115) is powered on (e.g., active state), powered off (e.g., off state), standby (e.g., idle state), etc. Temperature refers to a current measured temperature value of the component (e.g., the memory sub-system controller 115).

In some embodiments, the memory device 130 and/or 140 may provide, to the power management component 113, power consumption, power state, performance, temperature, data state metric (e.g., raw bit error rate (RBER)), workload characteristics, and historical workload of the memory device 130 and/or 140. Performance, as noted above, refers to speed and/or bandwidth of the memory device (e.g., memory device 130 and/or 140). Speed refers to how quickly data is read or written (e.g., speed, throughput, or transfer rate), often expressed in megabytes per second (MB/s) or gigabytes per second (GB/s) for sequential operations, and in IOPS (Input/Output Operations Per Second) for random operations. Bandwidth refers to a maximum amount of data that can be transferred in a given amount of time. Data state metric, such as RBER, refers to a measure of the quality or reliability of stored data in the memory device (e.g., memory device 130 and/or 140).

Workload characteristics refers to a nature of the queued operations, such as, whether the operations of the workload originate from the host or the memory sub-system, are reads or writes, are sequential or random, has a specific block size, are aligned or unaligned with boundaries of the memory device, etc. Historical workload refers to all workloads that were processed by the memory device 130 and/or 140.

In some embodiments, the backup capacitor may report, to the power management component 113, its temperature and charge level of the backup capacitor. Charge level of the backup capacitor is determined by a capacitance value of the backup capacitor and the voltage applied across it, thus when you increase the voltage across the backup capacitor, its charge level increases proportionally

In response to receiving, by the memory sub-system 110, a current workload, the power management component 113 provides the plurality of operational characteristics to the ML model. In some embodiments, the ML model is part of the host system 120 or a server. In some embodiments, one or more of the components of the memory sub-system 110 may include a portion of the ML model. The ML model is trained to output a set of parameters and their corresponding predicted parameter values based on the plurality of operational characteristics. The ML model provides the set of parameters and their corresponding predicted parameter values to the power management component. In some embodiments, the machine learning model may store all inputs (e.g., the operational characteristics) and resulting outputs (e.g., the set of parameters and their corresponding predicted parameter values) to dynamically learn from the interdependence between the inputs and resulting outputs, and or periodically (e.g., every predetermined period of time) retrained based on the historical workload which includes workloads since the last time the machine learning model was trained.

The power management component 113 receives the set of parameters and their corresponding predicted parameter values. The power management component 113 determines whether to update, based on the set of parameters and their corresponding predicted parameter values, a power management data structure (e.g., a power management table). Each entry of the power management table is identified by a parameter of the set of parameters and includes a current parameter value. For each parameter of the set of parameters, the power management component 113 identifies an entry matching a respective parameter. The power management component 113 compares a corresponding predicted parameter of the respective parameter with a current parameter value of the identified entry. If the corresponding predicted parameter of the respective parameter differs from the current parameter value of the identified entry, the power management component 113 replaces (or updates) the current parameter value of the identified entry with the corresponding predicted parameter of the respective parameter. The power management table may be stored in the memory device 130 and/or 140 of the memory sub-system.

In response to updating at least one entry of the power management table, the PMIC 150 may adjust the distribution of power within the memory sub-system 110 by adjusting the voltages on one or more voltage rails connected to the memory sub-system controller 115 and/or memory device (e.g., memory device 130 and/or 140). In some embodiments, the PMIC 150 may redirect power away from the backup capacitor to the memory sub-system controller 115 and/or memory device (e.g., memory device 130 and/or 140). In some embodiments, the PMIC 150 adjust the power credit of the PMIC 150. “Power credit” is a unit of power utilized for managing the power budget of operations of the memory sub-system controller. Thus, each operation performed by the memory sub-system controller 115 is allocated a specific number of power credits. Accordingly, the memory sub-system controller 115 determines, for each operation, based on the expected power consumption, whether enough power credits are available to perform an operation. Therefore, increasing the number of available power credits would increase the number of operations that can be performed simultaneously. Conversely, decreasing the number of available power credits would decreases the number of operations that can be performed simultaneously.

In some embodiments, the PMIC 150 may adjust a number of sub-functions executed by the memory sub-system controller 115. In other words, the PMIC 150 may disable all sub-functions or a portion of the sub-functions of the memory sub-system controller 115, thereby reclaiming power distributed to the memory sub-system controller 115 to be redistributed to other components (e.g., memory device 130 and/or 140). Further details with regards to the operations of the power management component 113 are described below.

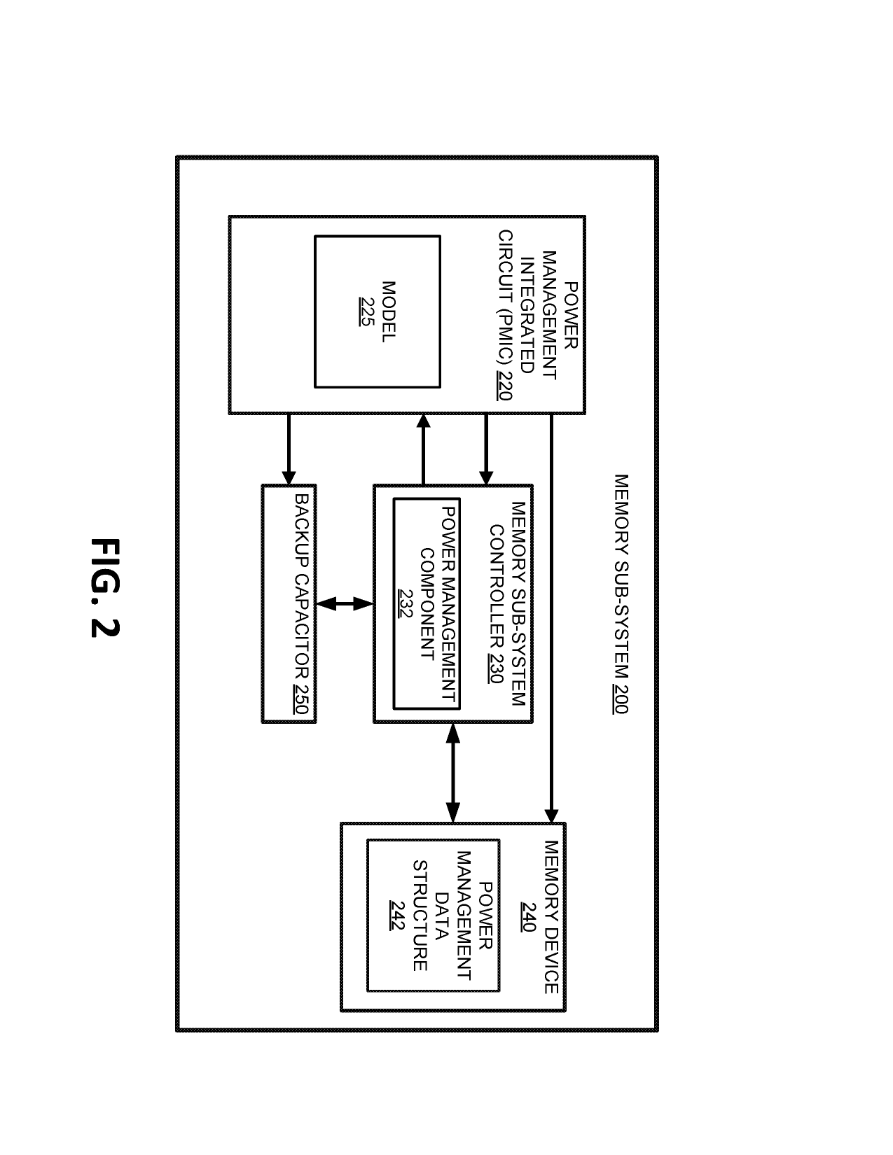

FIG. 2 illustrates an example memory sub-system 200, in accordance with some embodiments of the present disclosure. Memory sub-system 200, similar to memory sub-system 110 of FIG. 1, includes a power management integrated circuit (PMIC) 220, a memory sub-system controller 230 (similar to memory sub-system controller 115), and a memory device 240 (similar to memory device 130 and/or 140).

PMIC 220, as previously described, is responsible for regulating, distributing, and managing power received from a power source to memory sub-system controller 230 and memory device 240. More specifically, the memory sub-system controller 230 and the memory device 240 are supplied power by the PMIC via voltage rails. The amount of power supplied to the memory sub-system controller 230 and the memory device 240 may be dictated by a power management data structure (e.g., power management data structure 242). PMIC 220 may further include a machine learning model (e.g., model 225). As previously described, model 225 may be in a host system or server, or any other component of the memory sub-system 200. Model 225 is trained to receive operational characteristics of the memory sub-system controller 230 and/or the memory device 240 and output a set of parameters and their corresponding predicted parameter values used by the PMIC 220 to dynamically adjust power distribution to the memory sub-system controller 230 and/or the memory device 240.

Memory sub-system controller 230 may include a power management component 232. The power management component 232 monitors the memory sub-system controller 230 and the memory device 240 for a plurality of operational characteristics. The memory sub-system controller 230 may provide, to the power management component 232, a subset of the plurality of operational characteristics (e.g., power consumption, temperature, and power state). The memory device 240 may provide, to the power management component 232, a subset of the plurality of operational characteristics (e.g., power consumption, power state, performance, temperature, data state metric, workload characteristics, current workload, and historical workload).

Responsive to the memory sub-system 200 receiving a current workload, the power management component 232 provides the plurality of operational characteristics as input to model 225 to obtain a set of parameters and their corresponding predicted parameter values. The model 225 outputs and provides the set of parameters and their corresponding predicted parameter values to the power management component 232. The power management component 232, in response to receiving the set of parameters and their corresponding predicted parameter values, may update the power management data structure 242. For example, as previously described, for each parameter of the set of parameters, a corresponding predicted parameter of a respective parameter is compared with a current parameter value of a matching entry of the power management data structure 242. Based on the comparison, the matching entry of the power management data structure 242 is updated with the corresponding predicted parameter of the respective parameter. In response to updating at least one entry of the power management data structure 242, the PMIC 220 may adjust the distribution of power, via one or more voltage rails, to the memory sub-system controller 230 and/or memory device 240.

Depending on the embodiment, the memory sub-system 200 may further include a backup capacitor 250. Backup capacitor 250, as previously described, provides temporary power supply to the memory sub-system controller 230 experiencing loss of power, also referred to herein as asynchronous power loss (APL) or an APL event, to prevent data loss or other adverse effects. The backup capacitor 250 may provide a subset of the plurality of operational characteristics (e.g., temperature and charge level) to the memory sub-system controller 230. Accordingly, the set of parameters and their corresponding predicted parameter values outputted by the model 225 may cause the power management component 232 to update one or more entries in the power management data structure 242 that redirects power from the backup capacitor 250 to the memory sub-system controller 230 and/or memory device 240.

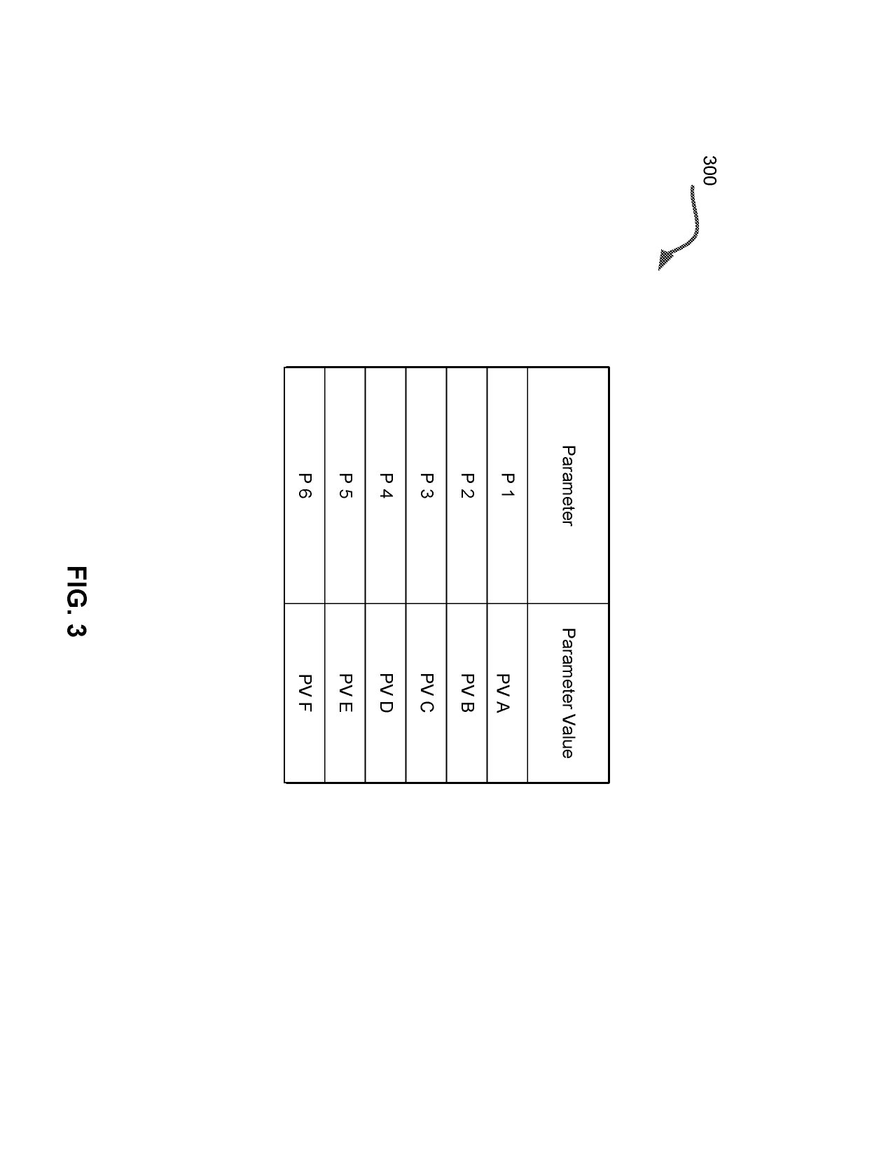

FIG. 3 illustrates an example power management data structure 300, in accordance with some embodiments of the present disclosure. Power management data structure 300 includes a plurality of entries. Each entry is identified by a parameter (P) (e.g., P 1 – 6) and includes a current parameter value (PV) (e.g., PV A- F, respectively). The PMIC (e.g., PMIC 220) utilizes the power management data structure 300 to distribute power to components within the memory sub-system.

As previously described, a memory sub-system controller (e.g., memory sub-system controller) or more specifically a power management component (e.g., power management component 232) monitors components within a memory sub-system (e.g., memory sub-system 200) for operational characteristics. The memory sub-system controller, in response to receiving a current workload, provides the operational characteristics to a machine learning model (e.g., model 225 of FIG. 2).

As previously described, the machine learning model is trained to output a set of parameters and their corresponding predicted parameters values based on the operational characteristics. The set of parameters includes, for example, memory sub-system controller voltage, programming voltage of the memory device(s), backup capacitor trigger, power credit, channel traffic prioritization, etc. The machine learning model provides the set of parameters and their corresponding predicted parameters values to the memory sub-system controller. The memory sub-system controller, in response to receiving the set of parameters and their corresponding predicted parameters values, determines whether to update the power management data structure 242.

As previously described, for each parameter of the set of parameters received from the machine learning model, the power management component identifies an entry of power management data structure 300 that matches a respective parameter. The power management component determines whether a corresponding parameter value of the respective parameter matches a current parameter value of the matching entry of the power management data structure 300. If the corresponding parameter value differs from the current parameter value, the power management component replaces the current parameter value with the corresponding parameter value in the matching entry of the power management data structure 300. In response to updating at least one entry of the power management data structure 300, based on the set of parameters and their corresponding predicted parameters values, the PMIC may adjust the distribution of power within the memory sub-system, redirect power away from the backup capacitor, adjust power credit, adjust sub-functions of the memory sub-system controller, etc.

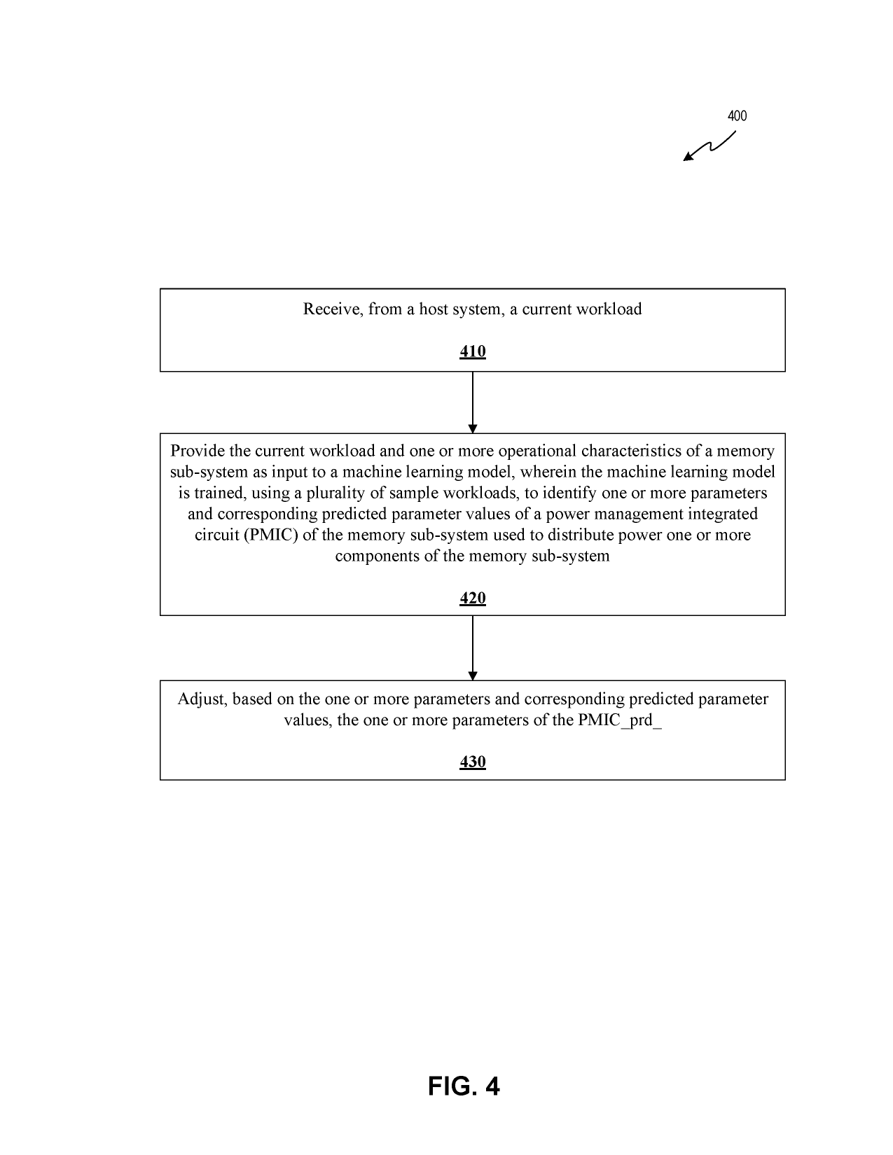

FIG. 4 is a flow diagram of an example method 400 to manage power delivery to components of a memory sub-system, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the power management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic receives, from a host system, a current workload. As previously described, workloads refer to a sequence of one or more memory access operations, such as read operations, write operations, and/or erase operations which are generated from applications (or software programs/systems) to be processed by the memory sub-system.

At operation 420, the processing logic provides the current workload and one or more operational characteristics of a memory sub-system as input to a machine learning model. As previously described, the processing logic monitors one or more components of the memory sub-system for one or more operational characteristics. The one or more operational characteristics may include power consumption, power state, performance, temperature, charge level, data state metrics, workload characteristics, and historical workloads of the one or more components of the memory sub-system. The one or more components of the memory sub-system may include one or more memory devices (or memory device(s)), a backup capacitor, a memory sub-system controller (or controller), and the PMIC.

In response to receiving the current workload, the processing logic provides the one or more operational characteristics obtained from the one or more components to the machine learning model. The machine learning model is trained, using a plurality of sample workloads, to identify one or more parameters and corresponding predicted parameter values of a power management integrated circuit (PMIC) of the memory sub-system, The PMIC may be used to distribute power the one or more components of the memory sub-system. As previously described, the one or more parameters may include memory sub-system controller voltage, programming voltage of the memory device(s), backup capacitor trigger, power credit, channel traffic prioritization, clock speed of the memory sub-system controller, operations of sub-functions of the memory sub-system controller, or prioritization of traffic flow.

At operation 430, the processing logic obtains an output of the machine learning model. The output comprising the one or more parameters and corresponding predicted parameter values. As previously described, the one or more parameters and corresponding predicted parameter values may be parameters of the PMIC which specify a predicted power to be distributed to the various components of the memory sub-system, by the PMIC, to efficiently execute the workload, maximize performance, and reduce ambient temperature of the memory sub-system.

At operation 440, the processing logic adjusts, based on the one or more parameters and corresponding predicted parameter values, the one or more parameters of the PMIC. More specifically, the processing logic identifies a power management data structure (or power management table) of the PMIC. Each entry of the power management table is identified by a parameter of the one or more parameters and includes a current parameter value. For each parameter of the one or more parameters, the processing logic identifies an entry matching a respective parameter. The processing logic compares a corresponding predicted parameter of the respective parameter with a current parameter value of the identified entry. If the corresponding predicted parameter of the respective parameter differs from the current parameter value of the identified entry, the processing logic updates (or replaces) the current parameter value of the identified entry with the corresponding predicted parameter of the respective parameter.

Depending on the embodiment, responsive to adjusting the one or more parameters of the PMIC, the processing logic causes the PMIC to distribute power based on the one or more parameters of the PMIC. In other words, the PMIC utilizes the power management table to distribute power to the one or more components. The processing logic proceeds to executing the current workload. Distributing power to the one or more components may include adjusting, based on the power management table, voltages on one or more voltage rails connected to the one or more components.

Depending on the embodiment, the machine learning model may be retrained based on a plurality of historical workload. The plurality of historical workload may include one or more workloads previously executed by the memory sub-system after the machine learning model was last trained. As previously described, every predetermined period of time the machine learning model is trained using the historical workload. Depending on the embodiment, as previously described, the machine learning model may dynamically learn interdependences between the inputs (e.g., the operational characteristics) and resulting outputs (e.g., the one or more parameters and their corresponding predicted parameter values).

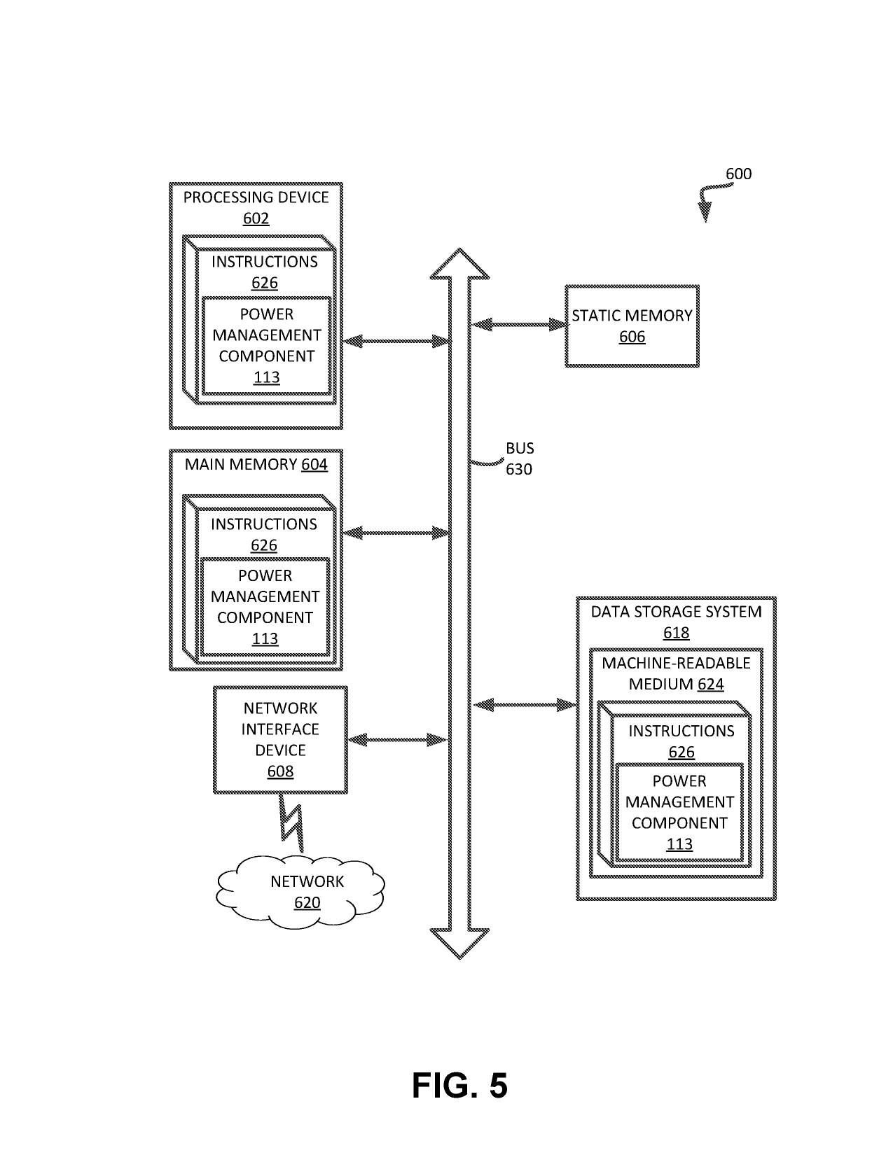

FIG. 5 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the power management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a power management component (e.g., the power management component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, from a host system, a current workload;
providing one or more characteristics of the current workload and one or more operational characteristics of a memory sub-system as input to a machine learning model, wherein the machine learning model is trained, using a plurality of sample workloads, to identify one or more parameters and corresponding predicted parameter values of a power management integrated circuit (PMIC) of the memory sub-system used to distribute power one or more components of the memory sub-system;
obtaining an output of the machine learning model, the output comprising the one or more parameters and corresponding predicted parameter values; and
adjusting, based on the one or more parameters and corresponding predicted parameter values, the one or more parameters of the PMIC.

2. The method of claim 1, wherein the one or more operational characteristics comprises:
power consumption, power state, performance, temperature, charge level, data state metrics, workload characteristics, and historical workloads of the one or more components of the memory sub-system.

3. The method of claim 2, wherein the one or more components of the memory sub-system includes at least one of: a memory device, a backup capacitor, a controller, or the PMIC.

4. The method of claim 1, wherein adjusting the one or more parameters of the PMIC comprises:
identifying a power management data structure of the PMIC, wherein the power management data structure comprises a plurality of entries, each entry corresponding to a parameter of the PMIC and includes a current parameter value; and
for each of the one or more parameters, identifying an entry of the power management data structure matching a respective parameter; comparing a corresponding predicted parameter values of the respective parameter with the current parameter value of the entry; and updating, based on the comparison, the current parameter value of the entry with the corresponding predicted parameter values.

5. The method of claim 1, further comprising:
responsive to adjusting the one or more parameters of the PMIC, causing the PMIC to distribute power based on the one or more parameters of the PMIC;
and executing the current workload.

6. The method of claim 5, wherein distributing power based on the one or more parameters of the PMIC comprises adjusting voltages on one or more voltage rails connected to the one or more components of the memory sub-system.

7. The method of claim 1, further comprising:retraining the machine learning model based on a plurality of historical workloads, wherein the plurality of historical workloads comprises one or more workloads previously executed by the memory sub-system after the machine learning model was last trained.

8. A system comprising:
a memory device; and
a processing device, operatively coupled with the memory device, to perform operations comprising:
receiving, from a host system, a current workload;
providing one or more characteristics of the current workload and one or more operational characteristics of a memory sub-system as input to a machine learning model, wherein the machine learning model is trained, using a plurality of sample workloads, to identify one or more parameters and corresponding predicted parameter values of a power management integrated circuit (PMIC) of the memory sub-system used to distribute power one or more components of the memory sub-system;
obtaining an output of the machine learning model, the output comprising the one or more parameters and corresponding predicted parameter values; and adjusting, based on the one or more parameters and corresponding predicted parameter values, the one or more parameters of the PMIC.

9. The system of claim 8, wherein the one or more operational characteristics comprises:
power consumption, power state, performance, temperature, charge level, data state metrics, workload characteristics, and historical workloads of the one or more components of the memory sub-system.

10. The system of claim 8, wherein the one or more components of the memory sub-system includes at least one of: a memory device, a backup capacitor, a controller, or the PMIC.

11. The system of claim 8, wherein adjusting the one or more parameters of the PMIC comprises:
identifying a power management data structure of the PMIC, wherein the power management data structure comprises a plurality of entries, each entry corresponding to a parameter of the PMIC and includes a current parameter value; and
for each of the one or more parameters, identifying an entry of the power management data structure matching a respective parameter;
comparing a corresponding predicted parameter values of the respective parameter with the current parameter value of the entry; and
updating, based on the comparison, the current parameter value of the entry with the corresponding predicted parameter values.

12. The system of claim 8, wherein the processing device is to perform operations further comprising:responsive to adjusting the one or more parameters of the PMIC, causing the PMIC to distribute power based on the one or more parameters of the PMIC; andexecuting the current workload.

13. The system of claim 12, wherein distributing power based on the one or more parameters of the PMIC comprises adjusting voltages on one or more voltage rails connected to the one or more components of the memory sub-system.

14. The system of claim 8, wherein the processing device is to perform operations further comprising:retraining the machine learning model based on a plurality of historical workloads, wherein the plurality of historical workload comprises one or more workloads previously executed by the memory sub-system after the machine learning model was last trained.

15. A non-transitory computer-readable storage medium comprising instructions that, when executed by a processing device, cause the processing device to perform operations comprising:
receiving, from a host system, a current workload;
providing one or more characteristics of the current workload and one or more operational characteristics of a memory sub-system as input to a machine learning model, wherein the machine learning model is trained, using a plurality of sample workloads, to identify one or more parameters and corresponding predicted parameter values of a power management integrated circuit (PMIC) of the memory sub-system used to distribute power one or more components of the memory sub-system;
obtaining an output of the machine learning model, the output comprising the one or more parameters and corresponding predicted parameter values; and
adjusting, based on the one or more parameters and corresponding predicted parameter values, the one or more parameters of the PMIC.

16. The non-transitory computer-readable storage medium of claim 15, wherein the one or more operational characteristics comprises: power consumption, power state, performance, temperature, charge level, data state metrics, workload characteristics, and historical workloads of the one or more components of the memory sub-system.

17. The non-transitory computer-readable storage medium of claim 15, wherein the one or more components of the memory sub-system includes at least one of: a memory device, a backup capacitor, a controller, or the PMIC.

18. The non-transitory computer-readable storage medium of claim 15, wherein adjusting the one or more parameters of the PMIC comprises:
identifying a power management data structure of the PMIC, wherein the power management data structure comprises a plurality of entries, each entry corresponding to a parameter of the PMIC and includes a current parameter value; and
for each of the one or more parameters, identifying an entry of the power management data structure matching a respective parameter;
comparing a corresponding predicted parameter values of the respective parameter with the current parameter value of the entry; and
updating, based on the comparison, the current parameter value of the entry with the corresponding predicted parameter values.

19. The non-transitory computer-readable storage medium of claim 15, wherein the processing device is further caused to perform operations comprising:
responsive to adjusting the one or more parameters of the PMIC, causing the PMIC to distribute power based on the one or more parameters of the PMIC; and
executing the current workload.

20. The non-transitory computer-readable storage medium of claim 15, wherein the processing device is further caused to perform operations comprising:
retraining the machine learning model based on a plurality of historical workloads, wherein the plurality of historical workload comprises one or more workloads previously executed by the memory sub-system after the machine learning model was last trained.
